(19) United States
(12) Patent Application Publication
(10) Pub. No.: US 2018/0078978 A1
(43) Pub. Date: Mar. 22, 2018

(54) SYSTEM FOR FLUSHING PIPE PLUMBING USING MICROBUBBLES, METHOD THEREFOR, AND SHIP OR MARITIME PLANT HAVING SAME

(71) Applicants: SAMYOUNG FIL-TECH CO., LTD., Seoul (KR); DAEWOO SHIPBUILDING & MARINE ENGINEERING CO., LTD., Seoul (KR)

(72) Inventors: Sang Hong KIM, Geoje-si (KR); Eul Seok MOON, Geoje-si (KR); Seaung Chae JU, Geoje-si (KR); Man Joo HUH, Geoje-si (KR); Kyung Hee LEE, Bucheon-si (KR)

(73) Assignees: SAMYOUNG FIL-TECH CO., LTD., Seoul (KR); DAEWOO SHIPBUILDING & MARINE ENGINEERING CO., LTD., Seoul (KR)

(21) Appl. No.: 15/564,144

(22) PCT Filed: Sep. 10, 2015
(86) PCT No.: PCT/KR2015/009513

§ 371 Date: Oct. 3, 2017

(30) Foreign Application Priority Data
Apr. 6, 2015 (KR) 10-2015-0048557

(51) Int. Cl. B08B 9/032; B01D 17/12; B01D 17/04; B01D 35/06; B01D 37/04; B03C 5/02

(52) U.S. Cl. CPC B08B 9/032; B01D 17/12; B03C 5/024; B01D 35/06; B01D 37/045; B01D 17/044

(57) ABSTRACT

A flushing system comprises: an oil tank for storing oil; a pipe system connected to the oil tank by means of a pipe to circulate the oil by means of the operation of a main pump; a microbubble generator connected to at least any one of the oil tank and the pipe system to generate the microbubbles in the pipe along which the oil flows and in the oil tank and thus to inject the microbubbles into the pipe; a water remover connected to the oil tank to remove the microbubbles and water from the oil; and a particle remover connected to the oil tank to remove microbubbles and foreign substances from the oil by means of electric precipitation.

### TECHNICAL FIELD

The present invention relates to a system and method for flushing a pipe using microbubbles, and more particularly, to a system and method for flushing a pipe using microbubbles that generates the microbubbles in oil to improve the moving and discharging capabilities of foreign substances along the pipe.

### BACKGROUND ART

Generally, a pipe serves as a path for inducing and moving a fluid to a given place.

If the pipe is used for a long period of time, the internal wall peripheral surface of the pipe becomes oxidized and eroded, and besides, all kinds of foreign substances contained in the fluid moving along the pipe are attached to the internal wall peripheral surface of the pipe to produce scales.

As time passes by, such scales are solidified to cause the path of the pipe to become narrow, and if the sectional area of the path of the pipe is reduced by means of the formation of the scales, the fluid does not move gently along the pipe, so that the pipe cannot perform its function as designed.

If the sectional area of the path of the pipe is reduced by means of the scales, in addition, the pipe may be broken due to the moving pressure of the fluid, and accordingly, the scales have to be immediately removed from the interior of the pipe so as to allow the pipe to perform its normal function.

So as to remove the scales from the interior of the pipe, in a conventional practice, water to which chemicals are added passes through the pipe, so that as the chemicals contained in the water come into contact with the scales, the scales are melted through chemical reactions.

As the chemicals are used, however, the removal of scales in the pipe through the chemicals should be carried out very carefully, and during the removal of the scales, further, the pipe may be damaged due to the use of the chemicals. Also, the removal cost for the scales may be raised because of high expensive chemicals.

In another conventional practice, on the other hand, the scales of the pipe are removed through compressed air. For example, after a pipe spool is made, compressed air is used to remove the scales like rust or blasting balls.

The scales (rust or blasting balls) of the pipe are strongly attached to the internal wall surface of the pipe by means of the water in the pipe, so that they cannot be perfectly removed just by means of the supply of compressed air to the interior of the pipe.

In addition, if the pipe is supplied and temporarily used on a construction site in the state where the scales are not removed completely from the interior of the pipe spool, a filter or strainer connected to the pipe may be broken, and especially, main processes like steam blowing and oil flushing may be delayed.

### DISCLOSURE

### Technical Problem

Accordingly, the present invention has been made in view of the above-mentioned problems occurring in the prior art, and it is an object of the present invention to provide a system and method for flushing a pipe using microbubbles and a ship or offshore plant having the same, wherein the microbubbles are generated in oil through a microbubble generator, thereby improving the moving and discharging capabilities of the foreign substances in the pipe, and water and foreign substances are removed from the oil by means of a water remover and electric precipitation (adsorption), thereby increasing the efficiency of work and observing the process of work.

### Technical Solution

To accomplish the above-mentioned object, according to a first aspect of the present invention, there is provided a system for flushing a pipe using microbubbles, the system including: an oil tank for storing oil; a pipe system connected to the oil tank by means of a pipe to circulate the oil by means of the operation of a main pump; a microbubble generator connected to at least any one of the oil tank and the pipe system to generate the microbubbles in the pipe along which the oil flows and in the oil tank and thus to inject the microbubbles into the pipe; a water remover connected to the oil tank to remove the microbubbles and water from the oil; and a particle remover connected to the oil tank to remove microbubbles and foreign substances from the oil by means of electric precipitation.

According to the present invention, desirably, between the pipe system and the oil tank is disposed a filter for filtering the foreign substances in the oil.

According to the present invention, desirably, between the pipe system and the filter is disposed an oil contamination level analyzer for analyzing the contamination level of the oil in the pipe in real time.

According to the present invention, desirably, the oil contamination level analyzer includes an oil contamination level real-time monitoring system adapted to check the contamination state of the oil in the pipe in real time.

According to the present invention, desirably, the oil contamination level analyzer is provided to the form of a portable analyzer so that even if a worker is moved from the site to a given place, the contamination level of the oil in the pipe is analyzed.

According to the present invention, desirably, the oil tank includes an auxiliary oil tank adapted to suck/supplement the oil thereto upon the lack of the oil.

According to the present invention, desirably, the auxiliary oil tank supplements the oil to the oil tank through an oil conveying pump for the particle remover.

According to the present invention, desirably, the auxiliary oil tank includes an oil sucking/discharging multi-manifolder adapted to change the flow of oil forwardly and reversely.

According to the present invention, desirably, the water remover is connected to the oil tank by means of a first pipe disposed separately from the pipe connecting the oil tank to the main pump.

According to the present invention, desirably, the particle remover is connected to the oil tank by means of a second pipe disposed separately from the pipe connecting the oil tank to the main pump.

To accomplish the above-mentioned object, according to a second aspect of the present invention, there is provided a method for flushing a pipe using microbubbles, the method including: the step of generating the microbubbles by means of a microbubble generator to inject the microbubbles into a pipe along which the oil discharged from an oil tank moves; the step of connecting a water remover to the oil tank to remove the microbubbles and water contained in the oil flowing from the oil tank to the pipe; and the step of connecting a particle remover to the oil tank to remove the microbubbles and foreign substances contained in the oil.

According to the present invention, desirably, the step of generating the microbubbles by means of the microbubble generator to inject the microbubbles into the pipe further includes the step of analyzing and monitoring the contamination level of the oil in the pipe in real time on a site by means of an oil contamination level analyzer when the microbubbles generated from the microbubble generator are injected into the pipe.

According to the present invention, desirably, the step of removing the microbubbles and water in the oil by means of the water remover is carried out by sucking the oil from the oil tank through the high vacuum force of an upper chamber of the water remover obtained by a vacuum pump adapted to make the upper chamber of the water remover under double high vacuum, by spraying the sucked oil through a filter inside the upper chamber to collect the sprayed oil to the lower portion of the upper chamber, by automatically discharging the oil to a lower chamber by means of a pneumatic solenoid valve connecting the upper chamber and the lower chamber with each other if the oil is over a given level (decreased in a vacuum degree), and by conveying the oil collected in the lower chamber to the oil tank by means of a fluid conveying pump in a tank to tank circulating way.

According to the present invention, desirably, the step of removing the microbubbles and foreign substances in the oil by means of the particle remover further includes the step of sucking/supplementing the oil to the oil tank through an auxiliary oil tank using a system pump if the oil stored in the oil tank is insufficient.

According to the present invention, desirably, the step of removing the microbubbles and foreign substances in the oil by means of the particle remover is carried out by sucking the oil to the lower portion of the particle remover through an oil conveying pump for the particle remover from the oil tank, by allowing the sucked oil to pass through the electrode plates to attach the foreign substances in the oil to the electrode plates by means of corona discharge, and by conveying the oil to the oil tank by means of the discharging force of the oil conveying pump in a tank to tank circulating way if the oil is filled to the upper portion of the particle remover.

To accomplish the above-mentioned object, according to a third aspect of the present invention, there is provided a ship or offshore plant having a system for flushing a pipe using microbubbles, wherein the system includes a microbubble generator disposed in a pipe along which oil flows from an oil tank to generate the microbubbles in the pipe and thus to inject the microbubbles into the pipe and a water remover and a particle remover disposed in the oil tank to remove the microbubbles, water and foreign substances from the oil.

### Advantageous Effects

According to the present invention, the system and method for flushing a pipe using microbubbles are provided with the microbubble generator from which the microbubbles are generated to increase the removal efficiency of the foreign substances in the pipe and also to increase the flow rate of oil through the decrement of oil viscosity to raise Reynolds number.

In addition, the system and method for flushing a pipe using microbubbles according to the present invention remove the water from the oil by means of the water remover to increase the life span and efficiency of the pipe and also remove the foreign substances from the oil through electrical adsorption of the particle remover, thereby needing no filter consumption.

Moreover, the system and method for flushing a pipe using microbubbles according to the present invention monitor the contamination level of oil in the pipe in real time on a site, thereby maximizing the efficiency of process.

### DESCRIPTION OF DRAWINGS

FIG. 1 is a block diagram showing a system for flushing a pipe using microbubbles according to the present invention.

FIG. 2 is a perspective view showing the interior of a microbubble generator in the system according to the present invention.

FIG. 3 is a sectional view showing the microbubble generator of FIG. 2.

FIG. 4 is a block diagram showing a water remover in the system according to the present invention.

FIG. 5 is a block diagram showing the internal structure of a particle remover in the system according to the present invention.

FIG. 6 is a sectional view showing the electrodes of the particle remover of FIG. 5.

FIG. 7 is a flowchart showing a method for flushing a pipe using microbubbles according to the present invention.

FIG. 8 is a flowchart showing the step of generating the microbubbles in the method according to the present invention.

FIG. 9 is a flowchart showing the step of removing foreign substances in the method according to the present invention.

FIG. 10 is a graph showing the test results wherein water is removed from oil in the system according to the present invention.

FIG. 11 is a graph showing the test results wherein particles are removed from oil in the system according to the present invention.

### EXPLANATION ON REFERENCE NUMERALS IN THE DRAWINGS

| | |
|---|---|
| 100: oil tank | 110: main pump |
| 120, 120a, 120b: pipe | 130: filter |
| 200: pipe system | 300: microbubble generator |
| 310: body | 311: air inlet |
| 312: oil inlet | 313: oil outlet |

320: rotation inducing and guiding unit
321, 322: guide wall

| | |
|---|---|
| 400: water remover | 410: upper chamber assembly |
| 411: upper chamber | 412: injection nozzle |

420: lower chamber assembly
421: first opening/closing valve

| | |
|---|---|
| 422: first pipe | 423: lower chamber |
| 424: water level sensor | 430: fluid discharging unit |
| 431: second opening/closing valve | 432: second pipe |

433: fluid conveying pump
434: vacuum adjusting unit

| | |
|---|---|
| 440: controller | 450: vacuum pump |
| 451: third pipe | 500: particle remover |
| 510: honeycomb | 520: discharge electrode frame |
| 530: discharge electrode | 540: earth electrode |
| 550, 551: electrode | 550a, 551a: surface coating material |
| 560: high voltage generator | 570: casing |

580: collecting filter
600: oil contamination level analyzer
610: oil contamination level real-time monitoring system
700: auxiliary oil tank
710: oil sucking/discharging multi-manifolder

### MODE FOR INVENTION

Hereinafter, the present invention will now be described in detail with reference to the attached drawing.

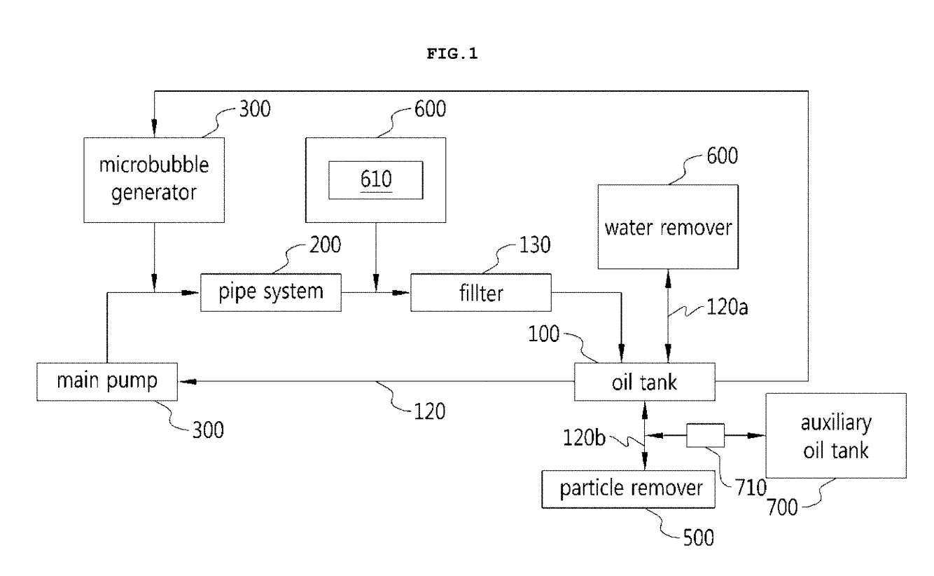

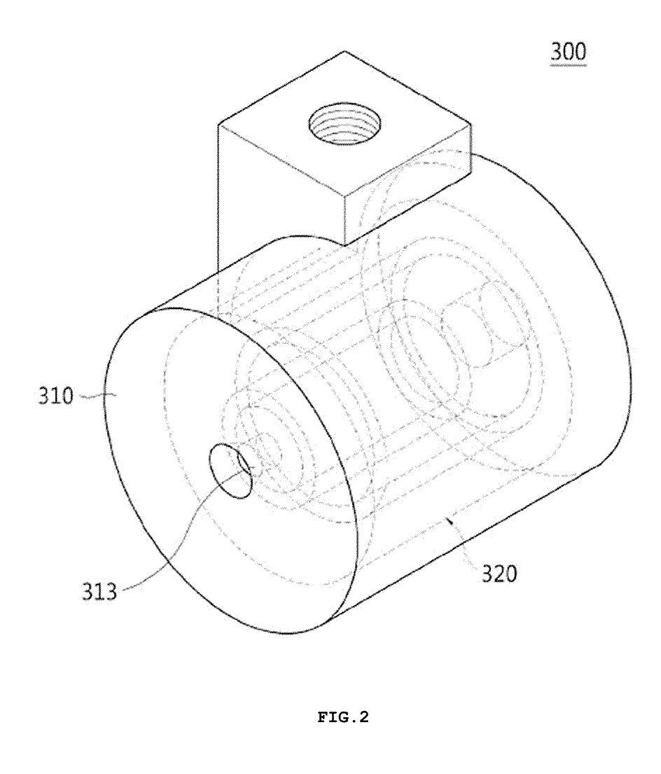

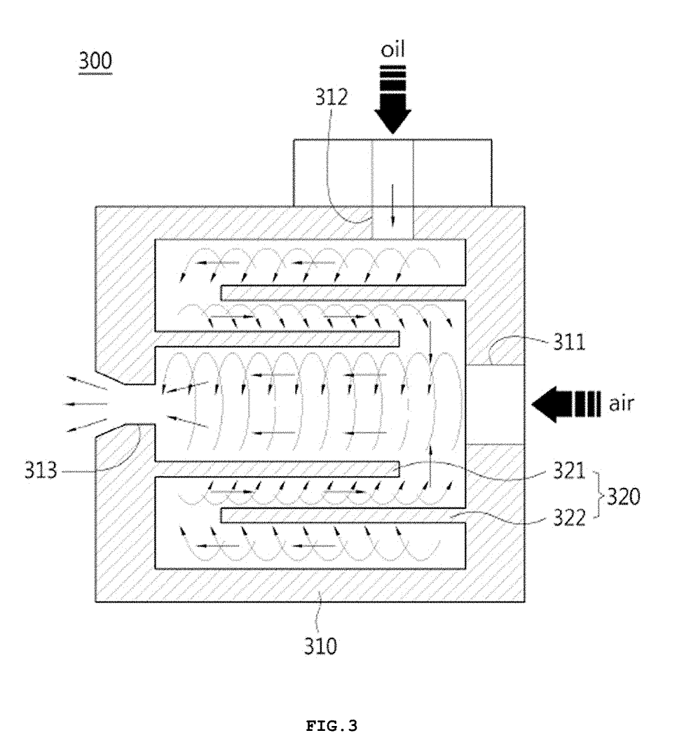

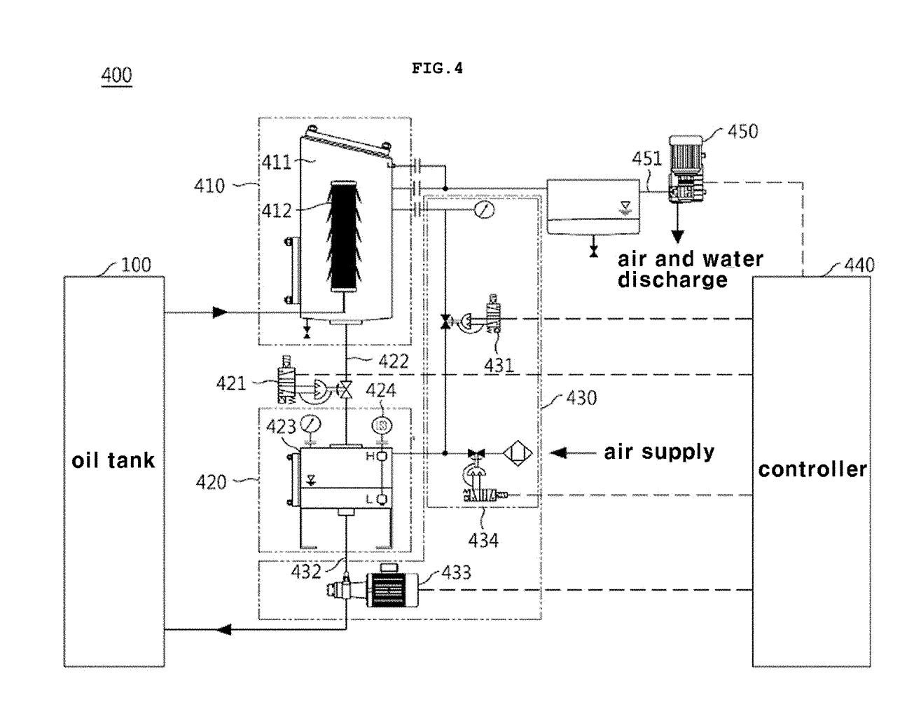

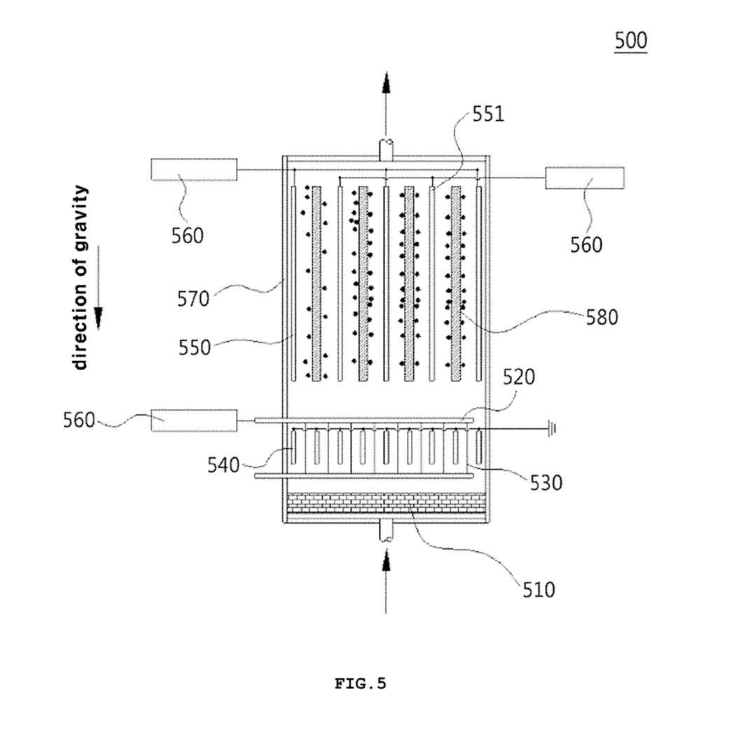

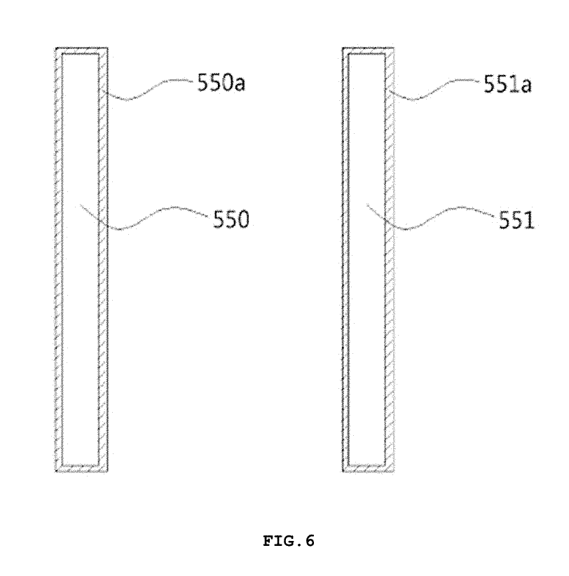

FIG. 1 is a block diagram showing a system for flushing a pipe using microbubbles according to the present invention, FIG. 2 is a perspective view showing the interior of a microbubble generator in the system according to the present invention, FIG. 3 is a sectional view showing the microbubble generator of FIG. 2, FIG. 4 is a block diagram showing a water remover in the system according to the present invention, FIG. 5 is a block diagram showing the internal structure of a particle remover in the system according to the present invention, and FIG. 6 is a sectional view showing the electrodes of the particle remover of FIG. 5.

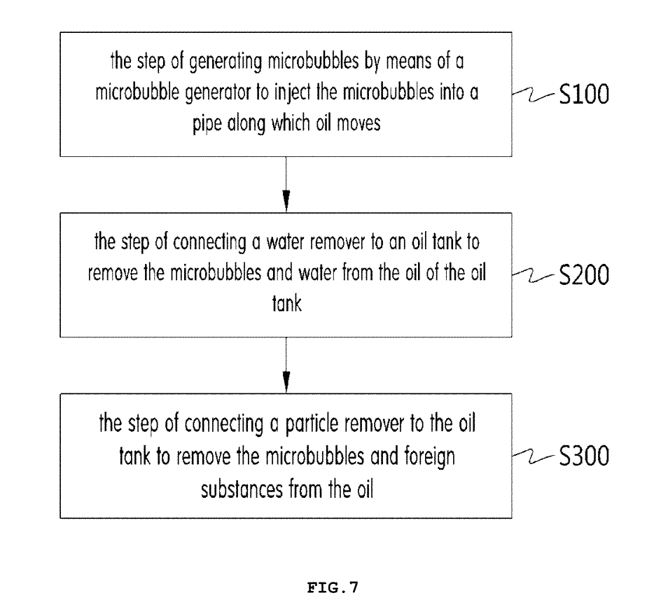

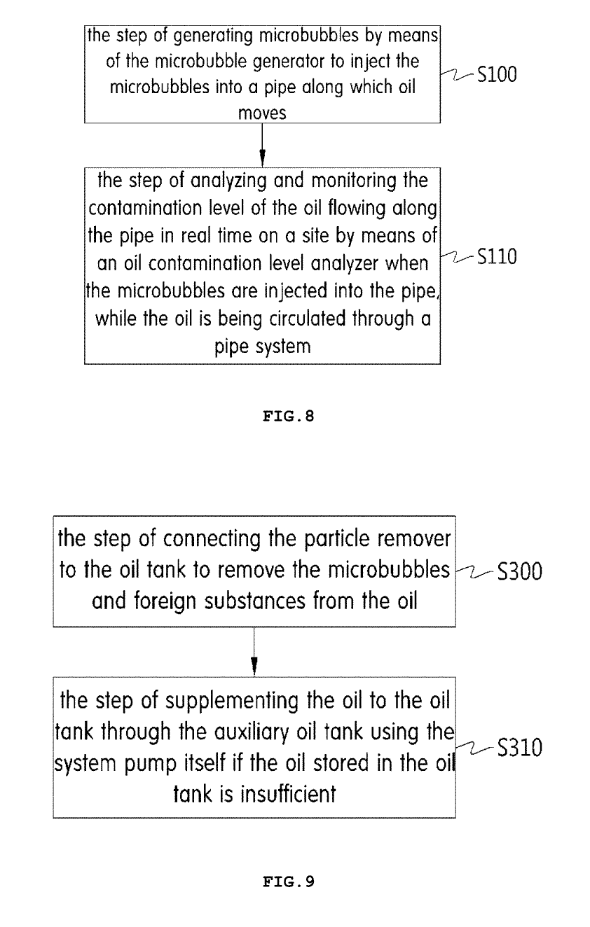

FIG. 7 is a flowchart showing a method for flushing a pipe using microbubbles according to the present invention, FIG. 8 is a flowchart showing the step of generating the microbubbles in the method according to the present invention, and FIG. 9 is a flowchart showing the step of removing foreign substances in the method according to the present invention.

As shown in FIGS. 1 to 6, a system for flushing a pipe using microbubbles according to the present invention includes an oil tank 100, a pipe system 200, a microbubble generator 300, a water remover 400, and a particle remover 500.

As shown in FIG. 1, the pipe system 200 is connected to the oil tank 100 by means of a pipe 120 so as to circulate oil by means of the operation of a main pump 110.

A filter 130 is located between the pipe system 200 and the oil tank 100 to filter the foreign substances contained in the oil circulated by the operation of the main pump 110.

Further, an oil contamination level analyzer 600 is disposed on the pipe 120 to measure the contamination level of the oil discharged from the oil tank 100 and thus flowing to the pipe 120 through the pipe system 200.

The oil contamination level analyzer 600 includes an oil contamination level real-time monitoring system 610 adapted to in real time monitor the contamination state of the oil discharged from the oil tank 100 and flowing to the pipe 120.

That is, the contamination level of the oil flowing to the pipe 120 is analyzed through the oil contamination level analyzer 600 on a site, and also, the contamination level of the oil in the pipe 120 is monitored and checked in real time through the oil contamination level real-time monitoring system 610.

Moreover, the oil contamination level analyzer 600 is provided to the form of a portable analyzer so that even if a worker is moved from the site to a given place, the contamination level of the oil flowing to the pipe 120 is monitored and analyzed.

The microbubble generator 300 is connected to at least any one of the oil tank 100 and the pipe system 200 to generate microbubbles from the pipe 120 along which the oil flows and from the oil tank 100 and thus to inject the microbubbles into the pipe 120, to pass the microbubbles through the water remover 400 and the particle remover 500, and finally to remove the water and foreign substances contained in the oil flowing in the pipe 120.

As shown in FIGS. 2 and 3, the microbubble generator 300 is a device for generating (producing) microbubbles having sizes of several hundred micrometers or under, for example, sizes of 100 micrometers or under and includes a body 310 and a rotation inducing and guiding unit 320 disposed inside the body 310.

The body 310 includes an air inlet 311 for introducing air, an oil inlet 312 for introducing the oil flowing along the pipe 120 through a pump at the different position from the air inlet 311, and an oil outlet 313 for discharging the oil in which the microbubbles are generated by means of the interaction of the air and oil.

The rotation inducing and guiding unit 320 is disposed inside the body 310 to induce the rotation of the oil introduced into the body 310 and thus to guide the oil to the air introduced through the air inlet 311.

Further, the rotation inducing and guiding unit 320 includes a plurality of guide walls 321 and 322 located along imaginary lines connecting the air inlet 311 and the oil outlet 313 to permit the oil to flow from the oil inlet 312 to the oil outlet 313.

As shown in FIG. 4, the water remover 400 of the system according to the present invention includes an upper chamber assembly 410, a lower chamber assembly 420, a fluid discharging unit 430, a controller 440, and a vacuum pump 450.

The upper chamber assembly 410 includes an upper chamber 411 in which a given high vacuum and pressure is maintained and an injection nozzle 412 disposed inside the upper chamber 411 to inject the supplied oil in which water is dissolved.

The lower chamber assembly 420 includes a lower chamber 423 connected to the upper chamber 411 by means of a first pipe 422 having a first opening/closing valve 421 to store the fluid from which the dissolved water discharged from the upper chamber 411 is removed and a water level sensor 424 adapted to sense the level of the fluid stored in the lower chamber 423.

The fluid discharging unit 430 includes a fluid conveying pump 433 connected to the lower chamber 423 by means of a second pipe 432 having a second opening/closing valve 431 and a vacuum adjusting unit 434 adapted to finely release the vacuum state of the lower chamber 423 when the fluid is discharged from the lower chamber 423 and adapted to allow the upper chamber 411 and the lower chamber 423 to be under a given vacuum pressure after the fluid is discharged.

The fluid conveying pump 433 is connected to the lower chamber 423 through the second pipe 432 and serves to discharge the fluid stored in the lower chamber 423 when the first opening and closing valve 421 is closed.

The controller 440 serves to open and close the first opening and closing valve 421 and the second opening and closing valve 431 and to operate the fluid conveying pump 433 and the vacuum pump 450.

The vacuum pump 450 is connected to the upper chamber 411 by means of a third pipe 451 and serves to allow the interiors of the upper chamber 411 and the lower chamber 423 to be under a vacuum pressure state.

On the other hand, the water remover 400 is connected to the oil tank 100 by means of a pipe 120a disposed separately from the pipe 120 connecting the oil tank 100 to the main pump 110.

As shown in FIGS. 5 and 6, the particle remover 500 of the system according to the present invention includes a honeycomb 510 adapted to allow the oil to flow uniformly, a corona generator having a discharge electrode 530 and an earth electrode 540 connected to a discharge electrode frame 520, an electrode 550 to which a high voltage of an anode (cathode) is applied, an electrode 551 spaced apart from the electrode 550 by a given distance in such a manner as to allow a high voltage having an opposite polarity to the electrical polarity of the high voltage applied to the electrode 550 to be applied or earthed thereto, high voltage generators 560 for applying high voltages to the electrodes 550 and 551 and the discharge electrode 530, and a casing 570.

Further, the particle remover 500 includes collecting filters 580 disposed between the electrodes, that is, the electrode 550 and the electrode 551 having the opposite polarities to each other in a direction parallel to the surfaces of the electrodes 550 and 551 in such a manner as to allow contaminants to be directly attached thereto and surface coating materials 550a and 551a located on the external surfaces of the electrodes 550 and 551 to protect the electrodes 550 and 551 from the outside.

A process for removing the foreign substances from the oil through the particle remover 500 is carried out as follows. First, the oil is introduced from the oil tank 100 into the particle remover 500 and then passes through the honeycomb 510, so that the oil flows uniformly. Next, the oil in uniform flow passes through the corona generator, so that if a high voltage is applied from the high voltage generators 560 to the discharge electrode frame 520, a large quantity of charge is generated between the discharge electrode 530 and the earth electrode 540 by means of corona discharge and thus serves to charge particulate contaminants in the oil.

Next, the particulate contaminants charged in the corona generator are introduced into an electrostatic filter, and when they pass through the space between the electrode 550 and the electrode 551 to which the high voltages having the different polarities from each other are applied in the electrostatic filter, a strong electric field is formed between the electrodes by means of the application of high voltages. At this time, the particulate contaminants contained in the oil move in the directions of the electrodes by means of the electric force.

At this time, the contaminants moving by the electric force are collected on the surfaces of the collecting filters 580, and accordingly, the oil from which the contaminants are removed moves to the oil tank 100.

On the other hand, the particle remover 500 is connected to the oil tank 100 by means of a pipe 120b disposed separately from the pipe 120 connecting the oil tank 100 to the main pump 110.

Further, an auxiliary oil tank 700 is disposed between the oil tank 100 and the particle remover 500 to supplement the oil to the oil tank 100 upon the lack of the oil.

The auxiliary oil tank 700 automatically supplements the oil to the oil tank 100 by means of a system pump itself.

Furthermore, the auxiliary oil tank 700 has an oil sucking/discharging multi-manifolder 710 adapted to change the flow of oil forwardly and reversely.

As shown in FIGS. 1 and 7 to 9, a method for flushing a pipe using microbubbles according to the present invention includes the step S100 of generating the microbubbles by means of the microbubble generator 300 to inject the microbubbles into the pipe 120 along which the oil moves from the oil tank 100, the step S200 of connecting the water remover 400 to the oil tank 100 to remove the microbubbles and water contained in the oil, and the step S300 of connecting the particle remover 500 to the oil tank 100 to remove the microbubbles and foreign substances contained in the oil.

As shown in FIG. 8, the step S100 of generating the microbubbles by means of the microbubble generator 300 to inject the microbubbles into the pipe 120 further includes the step S110 of analyzing and monitoring the contamination level of the oil flowing along the pipe 120 in real time on a site by means of the oil contamination level analyzer 600 when the microbubbles generated from the microbubble generator 300 are injected into the pipe 120, while the oil of the oil tank 100 is being circulated through the pipe system 200 by means of the operation of the main pump 110.

When the oil of the oil tank 100 is being circulated through the pipe system 200, that is, the contamination level of the oil is analyzed by means of the oil contamination level analyzer 600, and if the oil is contaminated, the microbubbles are generated in the pipe 120 by means of the operation of the microbubble generator 300 and injected thereinto. Further, the foreign substances are removed from the oil by means of the particle remover 500, thereby removing the contamination of the oil.

The step S200 of removing the microbubbles and water contained in the oil by means of the water remover 400 is carried out by sucking the oil from the oil tank 100 through the high vacuum force of the upper chamber 411 of the water remover 400 obtained by the vacuum pump 450 adapted to allow the upper chamber 411 of the water remover 400 to be under double high vacuum, by spraying the sucked oil through the filter inside the upper chamber 411 to collect the sprayed oil to the lower portion of the upper chamber 411, by automatically discharging the oil to the lower chamber 423 by means of a pneumatic solenoid valve (not shown) connecting the upper chamber 411 and the lower chamber 423 with each other if the oil is over a given level (decreased in a vacuum degree), and by conveying the oil collected in the lower chamber 423 to the oil tank 100 by means of the fluid conveying pump 433 in a tank to tank circulating way.

As shown in FIG. 9, the step S300 of removing the microbubbles and foreign substances contained in the oil by means of the particle remover 500 further includes the step S310 of supplementing the oil to the oil tank 100 through the auxiliary oil tank 700 using the system pump itself if the oil stored in the oil tank 100 is insufficient.

The step S300 of removing the microbubbles and foreign substances contained in the oil by means of the particle remover 500 is carried out by forming a corona discharge layer in the oil tank 100 by means of the electric force of the particle remover 500 to remove the microbubbles and foreign substances contained in the oil by means of electric precipitation (adsorption).

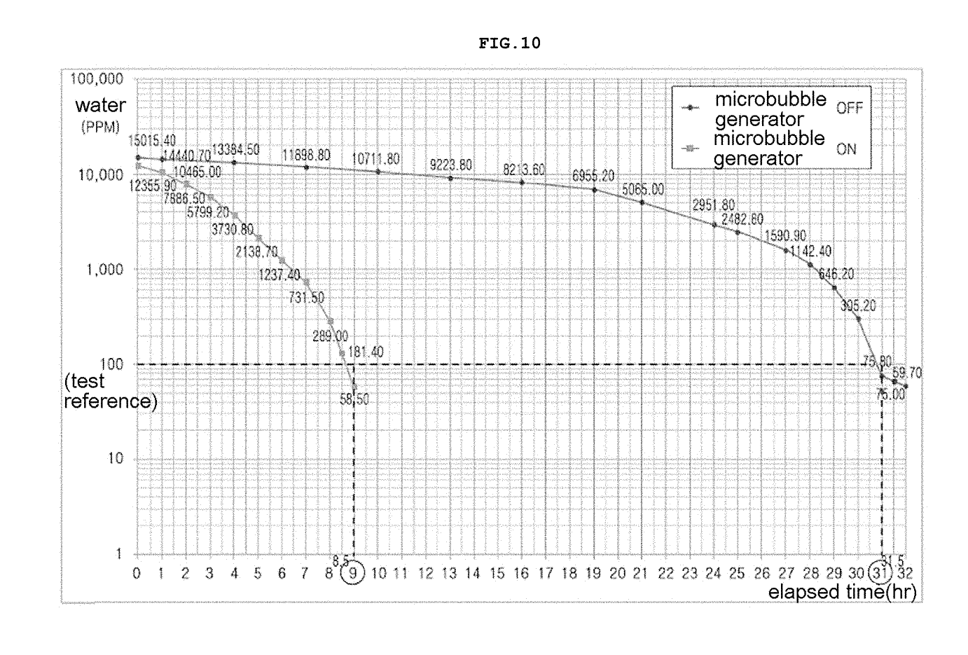

On the other hand, as shown in FIG. 10, the water existing in the oil is removed by means of the microbubble generator 300 and the water remover 400, thereby providing time shorter by about 71% than that required when the water in the oil is removed through chemicals in the conventional practice.

As listed in Tables 1 and 2 (water removal performance comparison test data in oil between conventional practice and the present invention), that is, about 31 hours are consumed to allow the water in the oil to be removed under 100 ppm in the conventional practice, but through the adoption of the microbubble generator 300 and the water remover 400, about 9 hours are consumed to allow the water in the oil to be removed under 100 ppm in the present invention.

TABLE 1
Water removal performance in conventional practice (bubble generator OFF)

| Sample No. | 1 | 2 | 3 | 4 | 5 | 6 | 7 | 8 | 9 |
|---|---|---|---|---|---|---|---|---|---|
| Operating time | 0 hr | 1 hr | 4 hr | 7 hr | 10 hr | 13 hr | 16 hr | 19 hr | 21 hr |
| Water (ppm) | 15,015.4 | 14,440.7 | 13,384.5 | 11,898.8 | 10,711.8 | 9,223.8 | 8,213.6 | 6,955.2 | 5,065.0 |

| Sample No. | 10 | 11 | 12 | 13 | 14 | 15 | 16 | 17 | 18 |
|---|---|---|---|---|---|---|---|---|---|
| Operating time | 24 hr | 25 hr | 27 hr | 28 hr | 29 hr | 30 hr | 31 hr | 31.5 hr | 32 hr |
| Water (ppm) | 2,951.8 | 2,482.8 | 1,590.9 | 1,142.4 | 646.2 | 305.2 | 75.8 | 75.0 | 59.7 |

TABLE 2
Water removal performance according to the present invention (bubble generator ON)

| Sample No. | 1 | 2 | 3 | 4 | 5 | 6 | 7 | 8 | 9 | 10 | 11 |
|---|---|---|---|---|---|---|---|---|---|---|---|
| Operating time | 0 hr | 1 hr | 2 hr | 3 hr | 4 hr | 5 hr | 6 hr | 7 hr | 8 hr | 8.5 hr | 9 hr |
| Water (ppm) | 12,355.9 | 10,465.0 | 7,886.5 | 5,799.2 | 3,730.8 | 2,138.7 | 1,237.4 | 731.5 | 289.0 | 181.4 | 58.5 |

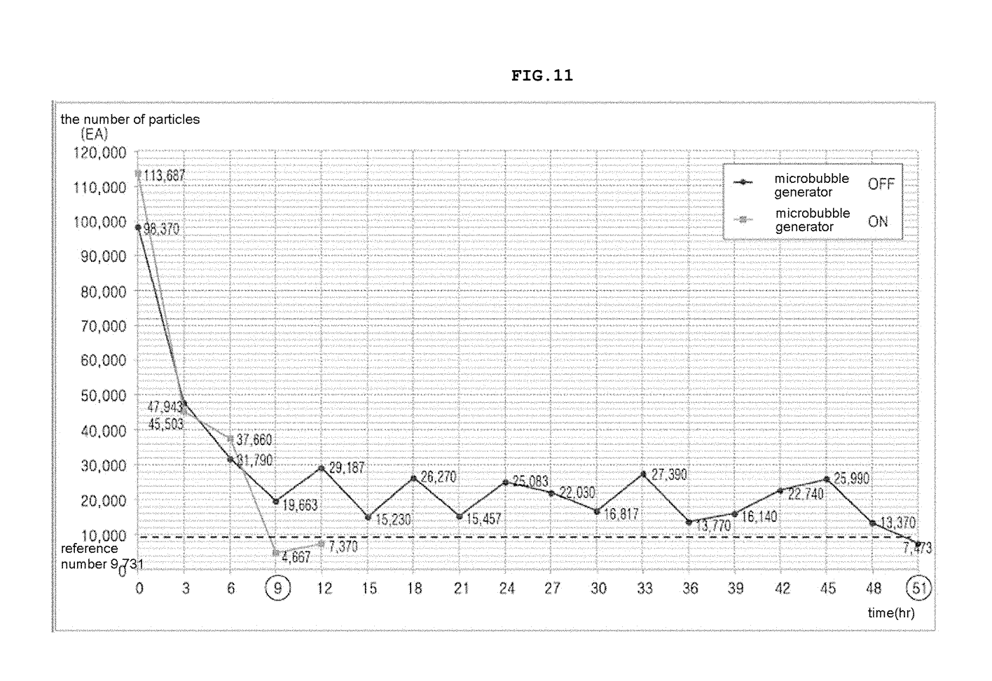

Further, as shown in FIG. 11, the particles existing in the oil are removed by means of the microbubble generator 300 and the particle remover 500, thereby providing time shorter by about 77% than that required when the particles in the oil are removed through chemicals in the conventional practice and further lowering the contamination level of the oil and the number of particles in the shortest time.

As listed in Tables 3 and 4 (particle removal performance comparison test data in oil between conventional practice and the present invention), that is, about 51 hours are consumed to allow the particles in the oil to be removed to lower the contamination level to a reference value in the conventional practice, but through the adoption of the microbubble generator 300 and the particle remover 500, about 9 hours are consumed to allow the particles in the oil to be removed to lower the contamination level to the reference value in the present invention.

TABLE 3
Particle removal performance in conventional practice (bubble generator OFF)

| | | | Particle distribution | | | | | |
|---|---|---|---|---|---|---|---|---|
| Sample | | | Total number | | | | | |
| No. | Time | | of particles | 5 μm≤ | 15 μm≤ | 25 μm≤ | 50 μm≤ | 100 μm≤ |
| 1 | 0 | hr | 121,489 | 98,370 | 15,210 | 6,663 | 1.163 | 83 |
| 2 | 3 | hr | 59,806 | 47,943 | 7,540 | 3,413 | 800 | 110 |
| 3 | 6 | hr | 37,400 | 31,970 | 3,877 | 1,470 | 240 | 23 |
| 4 | 9 | hr | 21,179 | 19,663 | 1,243 | 230 | 40 | 3 |
| 5 | 12 | hr | 33,624 | 29,187 | 3,260 | 967 | 190 | 20 |
| 6 | 15 | hr | 17,644 | 15,230 | 1,577 | 670 | 150 | 17 |
| 7 | 18 | hr | 30,097 | 26,270 | 2,607 | 990 | 197 | 33 |
| 8 | 21 | hr | 17,640 | 15,457 | 1,423 | 613 | 130 | 17 |
| 9 | 24 | hr | 28,293 | 25,083 | 2,250 | 797 | 140 | 23 |
| 10 | 27 | hr | 23,887 | 22,030 | 1,457 | 353 | 37 | 10 |
| 11 | 30 | hr | 17,730 | 16,817 | 710 | 150 | 43 | 10 |
| 12 | 33 | hr | 28,540 | 27,390 | 957 | 173 | 20 | 0 |
| 13 | 36 | hr | 14,483 | 13,770 | 573 | 120 | 20 | 0 |
| 14 | 39 | hr | 17,479 | 16,140 | 1,043 | 243 | 40 | 13 |
| 15 | 42 | hr | 23,821 | 22,740 | 867 | 167 | 40 | 7 |
| 16 | 45 | hr | 27,110 | 25,990 | 927 | 163 | 30 | 0 |
| 17 | 48 | hr | 13,947 | 13,370 | 487 | 87 | 3 | 0 |
| 18 | 51 | hr | 7,996 | 7,473 | 470 | 53 | 0 | 0 |

TABLE 4
Particle removal performance according to
the present invention (bubble generator ON)

| | | | Particle distribution | | | | | |
|---|---|---|---|---|---|---|---|---|
| Sample | | | Total number | | | | | |
| No. | Time | | of particles | 5 μm≤ | 15 μm≤ | 25 μm≤ | 50 μm≤ | 100 μm≤ |
| 1 | 0 | hr | 130,958 | 113,687 | 13,230 | 3,543 | 468 | 30 |
| 2 | 3 | hr | 48,520 | 45,503 | 2,797 | 203 | 17 | 0 |
| 3 | 6 | hr | 40,857 | 37,660 | 2,957 | 227 | 10 | 3 |
| 4 | 9 | hr | 4,847 | 4,667 | 130 | 20 | 0 | 0 |
| 5 | 12 | hr | 8,130 | 7,370 | 650 | 97 | 13 | 0 |

According to the present invention, a ship or offshore plant is provided with the system for flushing a pipe using microbubbles that is configured to have the microbubble generator 300 disposed in the pipe along which the oil flows from the oil tank 100 to generate the microbubbles in the pipe 120 by means of the microbubble generator 300 and thus to inject the microbubbles into the pipe 120, to have the water remover 400 disposed in the oil tank 100 to remove the microbubbles and water contained in the oil flowing along the pipe 120a from the oil tank 100, and to have the particle remover 500 disposed in the oil tank 100 to remove the microbubbles and foreign substances contained in the oil flowing along the pipe 120b from the oil tank 100, thereby enhancing the life span and working efficiency of the pipe.

The microbubble generator 300 from which the microbubbles are generated is disposed in the pipe 120 along which the oil flows from the oil tank 100, so that the microbubbles are injected into the pipe 120, and further, the microbubbles and water contained in the oil are removed by means of the water remover 400 and the particle remover 500, thereby enhancing the life span of the pipe 120 and the performance of the product. Accordingly, the system for flushing the pipe using microbubbles according to the present invention can be applied to all kinds of ships or offshore plants.

According to the present invention, the system and method for flushing the pipe using microbubbles are configured to allow the oil stored in the oil tank 100 to be circulated through the pipe system 200 by means of the operation of the main pump 110.

At this time, the contamination level of the oil flowing along the pipe 120 is analyzed and monitored in real time on a site by means of the oil contamination level analyzer 600, while the oil of the oil tank 100 is being circulated through the pipe 120.

If it is analyzed through the oil contamination level analyzer 600 that the oil is contaminated, the microbubbles are generated by means of the operation of the microbubble generator 300, and the foreign substances produced in the pipe 120 by the microbubbles are transferred by an impact force and are thus absorbed to the outside or float.

At this time, the microbubbles are generated from the microbubble generator 300 to remove the foreign substances in the pipe 120, thereby raising Reynolds number according to the increment of flow rate in the pipe 120.

Also, the water remover 400 is connected to the oil tank 100 by means of the pipe 120a disposed separately from the pipe 120 connecting the oil tank 100 to the main pump 110, so that the boiling point of water contained in the oil of the oil tank 100 is increased by means of the double high vacuum generated from the water remover 400, and the water in the oil injected from the injection nozzle 412 is vaporized and separated.

Further, the water in the oil is condensed by means of a condensing chamber of the water remover 400 and is automatically discharged.

Moreover, the particle remover 500 is connected to the oil tank 100 by means of the pipe 120b disposed separately from the pipe 120 connecting the oil tank 100 to the main pump 110, so that the corona discharge layer is formed in the particle remover 500 by means of the electric force to charge the surfaces of the contaminated particles thereto, and the foreign substances are moved to the opposite polarity to the charged polarity and are attached and removed to the collecting filters 580, thereby transferring the oil from which the foreign substances are removed to the oil tank 100.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A system for flushing a pipe using microbubbles, the system comprising:
an oil tank for storing oil;
a pipe system connected to the oil tank by means of a pipe to circulate the oil by means of the operation of a main pump;
a microbubble generator connected to at least any one of the oil tank and the pipe system to generate the microbubbles in the pipe along which the oil flows and in the oil tank and thus to inject the microbubbles into the pipe;
a water remover connected to the oil tank to remove the microbubbles and water from the oil; and
a particle remover connected to the oil tank to remove microbubbles and foreign substances from the oil by means of electric precipitation.

2. The system according to claim 1, wherein between the pipe system and the oil tank is disposed a filter for filtering the foreign substances in the oil.

3. The system according to claim 2, wherein between the pipe system and the filter is disposed an oil contamination level analyzer for analyzing the contamination level of the oil in the pipe in real time.

4. The system according to claim 3, wherein the oil contamination level analyzer comprises an oil contamination level real-time monitoring system adapted to check the contamination state of the oil in the pipe in real time.

5. The system according to claim 3, wherein the oil contamination level analyzer is provided to the form of a portable analyzer so that even if a worker is moved from the site to a given place, the contamination level of the oil in the pipe is analyzed.

6. The system according to claim 1, wherein the oil tank comprises an auxiliary oil tank adapted to suck/supplement the oil thereto upon the lack of the oil.

7. The system according to claim 6, wherein the auxiliary oil tank supplements the oil to the oil tank through an oil conveying pump for the particle remover.

8. The system according to claim 6, wherein the auxiliary oil tank comprises an oil sucking/discharging multi-manifolder adapted to change the flow of oil forwardly and reversely.

9. The system according to claim 1, wherein the water remover is connected to the oil tank by means of a first pipe disposed separately from the pipe connecting the oil tank to the main pump.

10. The system according to claim 1, wherein the particle remover is connected to the oil tank by means of a second pipe disposed separately from the pipe connecting the oil tank to the main pump.

11. A method for flushing a pipe using microbubbles, the method comprising:
the step of generating the microbubbles by means of a microbubble generator to inject the microbubbles into a pipe along which the oil discharged from an oil tank moves;
the step of connecting a water remover to the oil tank to remove the microbubbles and water contained in the oil flowing from the oil tank to the pipe; and
the step of connecting a particle remover to the oil tank to remove the microbubbles and foreign substances contained in the oil.

12. The method according to claim 11, wherein the step of generating the microbubbles by means of the microbubble generator to inject the microbubbles into the pipe further comprises the step of analyzing and monitoring the contamination level of the oil in the pipe in real time on a site by means of an oil contamination level analyzer when the microbubbles generated from the microbubble generator are injected into the pipe.

13. The method according to claim 11, wherein the step of removing the microbubbles and water in the oil by means of the water remover is carried out by sucking the oil mixed with the microbubbles generated by the microbubble generator and injected into the pipe to the water remover through the pipe to remove the microbubbles and water from the oil by means of double high vacuum.

14. The method according to claim 11, wherein the step of removing the microbubbles and foreign substances in the oil by means of the particle remover further comprises the step of sucking/supplementing the oil to the oil tank through an auxiliary oil tank using a system pump if the oil stored in the oil tank is insufficient.

15. The method according to claim 11, wherein the step of removing the microbubbles and foreign substances in the oil by means of the particle remover is carried out by sucking the oil mixed with the microbubbles generated by the microbubble generator and injected into the pipe to the particle remover and by forming a corona discharge layer by means of the electric force of the particle remover to remove the microbubbles and foreign substances in the oil by means of electric precipitation (adsorption).

16. A ship having the system for flushing the pipe using microbubbles according to claim 1, wherein the system comprises the microbubble generator disposed in the pipe along which the oil flows from the oil tank to generate the microbubbles in the pipe and thus to inject the microbubbles into the pipe and the water remover and the particle remover disposed in the oil tank to remove the microbubbles, water and foreign substances from the oil.

17. An offshore plant having the system for flushing the pipe using microbubbles according to claim 1.
